(19) United States
(12) Patent Application Publication
(10) Pub. No.: US 2003/0115585 A1
(43) Pub. Date: Jun. 19, 2003

(54) Enhanced electronic program guide

(75) Inventors: Eric Lawrence Barsness, Pine Island, MN (US); Cary Lee Bates, Rochester, MN (US); Paul Reuben Day, Rochester, MN (US); Robert Richard Rasch, San Jose, CA (US); John Matthew Santosuosso, Rochester, MN (US)

Correspondence Address: Gero G. McClellan, Thomason, Moser & Patterson, L.L.P., 3040 Post Oak Boulevard, Suite 1500, Houston, TX, 77056-6582, US

(73) Assignee: International Business Machines Corporation, Armonk, NY (US)

(21) Appl. No.: 09/903,350

(22) Filed: Jul. 11, 2001

(51) Int. Cl. H04N 7/16; H04H 9/00; H04N 7/173; H04N 7/025; H04N 7/10; G06F 3/00; H04N 5/445; G06F 13/00

(52) U.S. Cl. 725/9; 725/14; 725/35; 725/46; 725/39; 348/563; 348/564

(57) ABSTRACT

An on-screen program guide formatted with viewership information is provided. In general, viewership data is collected from a plurality of viewers via, e.g., cable and satellite receivers. The viewership data is then processed to provide viewership information including viewership interest, viewership growth rates, surfing behavior, and other viewership behavior. The viewership interest may also include group member information such as which members of a group are watching a particular program, group ratings of a program, individual member ratings of a program and the like. The viewership information may then be transmitted back to the viewers and displayed as part of an on-screen program guide or other visual interface.

### BACKGROUND OF THE INVENTION

1. Field of the Invention

The present invention generally relates to data processing. More particularly, embodiments of the invention relate to an on-screen program guide.

2. Description of the Related Art

On-screen program guides are well-known. These electronic guides provide graphical interfaces which aid television viewers. In general, on-screen program guides can be formatted to display a plurality of channels and their associated programming. Using the guide, viewers can browse program information such as program descriptions, time schedules, etc. In addition, viewers can select a current program from the guide.

Despite the advantages and flexibility of on-screen guides, a number of problems persist for today's viewing audiences. One problem is that viewers are faced with a growing number of available channels. Even with the availability of custom controls of the on-screen guide (e.g., keyword searches, bookmarks, category filters, etc.) and other supporting technology (e.g., TiVo), viewers find it difficult to locate shows/channels of interest.

Therefore, a need exists to provide television viewers with meaningful information which may facilitate selection of programs or channels.

### SUMMARY OF THE INVENTION

The present invention generally provides embodiments of an on-screen program guide formatted with viewership information.

In one embodiment a method of providing viewership information to a plurality of television viewers is provided. The method comprises collecting viewership data of a plurality of viewers; processing the viewership data to provide on-screen interface information; and transmitting, to a plurality of end-user receivers, the on-screen interface information. The on-screen interface information is viewable on displays connected to the plurality of end-user receivers.

Another embodiment provides a signal processing unit for processing television signals comprising a first connector for receiving a video signal transmitted from a remote provider; a second connector for receiving a viewership signal containing viewership data collected from a plurality of viewers; a memory containing an on-screen guide interface formatable with the viewership data; and a processor configured to format the on-screen guide interface with the viewership data.

Still another embodiment provides an on-screen program guide information provider system, comprising a first network connection with a plurality of devices configured to collect viewership data of a plurality of television viewers; a second network connection with a plurality of end-user receivers; a processor configured to: (i) process the viewership data to provide on-screen guide formatting information and (ii) transmit, via the second network connection, the on-screen guide formatting information to the plurality of end-user receivers. The on-screen guide formatting information is used by the end-user receivers to output viewership indicators to displays connected to the plurality of end-user receivers.

Yet another embodiment provides a computer data signal embodied in a transmission medium, comprising on-screen program guide interface information containing viewership information of a plurality of television viewers, wherein the on-screen interface information is readable by a plurality of receivers having a network connection with a television program provider and wherein viewership information is configured for formatting an on-screen program guide.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a simplified block diagram of a networked system connecting subscribers to a programming provider.

FIG. 2 depicts a diagram of an entertainment system operable to communicate with the provider.

FIG. 3 is a data structure representing one embodiment of an aggregate viewership table.

FIG. 4 is a data structure representing one embodiment of an individual viewership table.

FIG. 5 is a method for maintaining individual viewership tables.

FIG. 6 is a method for sending and receiving viewership information.

FIG. 7 is a method for updating an aggregate viewership table.

FIG. 8 is a method for monitoring viewership interest change in a program.

FIG. 9 is a method for providing external information augmentation.

FIG. 10 is a method for formatting an on-screen program guide with viewership information

FIG. 11 is an illustrative interface of an on-screen program guide.

### DETAILED DESCRIPTION OF THE PREFERRED EMBODIMENTS

Embodiments of the present invention provide an on-screen program guide formatted with viewership information. In general, viewership data is collected from a plurality of viewers via, e.g., cable and satellite receivers. The viewership data is then processed to provide viewership information including viewership interest, viewership growth rates, surfing behavior, and other viewership behavior. The viewership interest may also include group member information such as which members of a group are watching a particular program, group ratings of a program, individual member ratings of a program and the like. The viewership information may then be transmitted back to the viewers and displayed as part of an on-screen program guide or other visual interface.

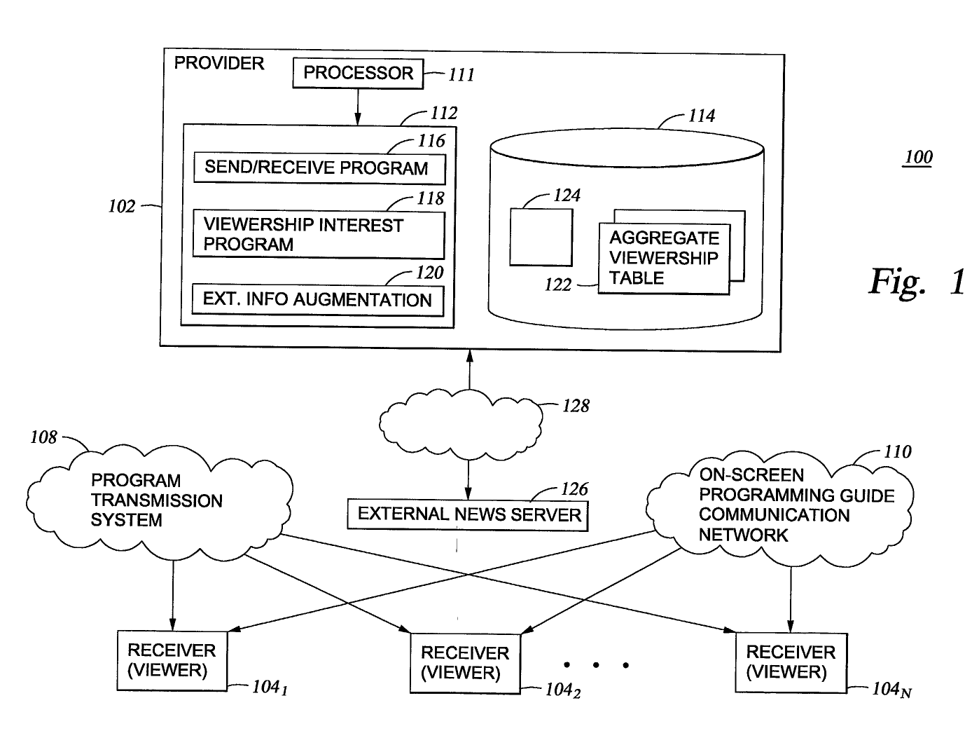

One embodiment of the invention is implemented as a program product for use with a computer system such as, for example, the network environment 100 shown in FIG. 1 and described below. The program(s) of the program product defines functions of the embodiments (including the methods described below) and can be contained on a variety of signal/bearing media. Illustrative signal/bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature. PPD C1

FIG. 1 is a high level diagram of a network environment 100 generally comprising a provider 102 and a plurality of receivers 104₁, 104₂, . . . 104_{N}. Each receiver 104 may represent a viewing entity. The provider 102 may be any entity (or entities) adapted to transmit visual and/or audio signals (programs) to the receivers 104 via a program transmission system 108. The transmitted programs may include pay-per-view movies, view-on-demand movies, broadcast television, network channels, syndicated channels and the like. Illustrative providers 102 include cable and satellite providers. In another embodiment, the provider 102 and the subscribers 104 are related as servers and clients in a distributed computer environment (e.g., the Internet).

As used herein, the term “viewing entity” or “viewer” means any entity controlling a receiver 104 and may include, for example, a person, a family and a corporation. In some embodiments the viewing entity is billed for the services of the provider 102. Accordingly, each viewing entity may be designated with a single account number (or invoicing number). In this context it is not necessary that the viewing entities 104 be in contractual relationship with the provider 102 in which the provider 102 provides a suite or package of programs for a periodic (e.g., monthly) payment. Rather each program may be made available for “ala carte” selection by the viewing entities.

The provider 102 includes a processor 111, a memory 112 and a database 114. The memory 112 contains a send/receive program 116, a viewership interest program 118 and an external information augmentation program 120. The database 114 contains information pertaining to each viewing entity. Such information may include each individual viewer's account number, name, addresses, credit card information, purchase orders for programming and the like. This information is used to generate an invoice for each viewing entity as well as provide enhancements (e.g., viewership information collected from viewers) to on-screen program guides executing on each receiver 104. The latter feature is specifically supported by an aggregate viewership table 122 and a group membership table 124. The use of these data structures to enhance on-screen program guides is described in more detail below.

For simplicity, the on-screen program guide information provider and the programming provider (e.g., satellite or cable) are shown as a single entity referred to as the provider 102. However, it is noted that the entity providing the on-screen program guide information may be separate from the programming provider.

The receivers 104 are each connected to the provider 102 by a communication network 110. The network 110 may be any system for connecting the receivers 104 and the provider 102 and allowing information exchange therebetween. In particular, the network 110 allows for transmission of on-screen programming guide information. Such information includes graphical interfaces and programming content and viewership information to augment or otherwise populate the interfaces. In one embodiment, the network 110 also allows communication between the individual viewers, particularly viewers in a common viewing group. Illustratively, the network 110 is the Internet. In other embodiments, the network 110 is a “plain old telephone system” (POTS) or a satellite network. In any case, communication is facilitated by the appropriate transmission protocols and hardware support. Although shown separately, in one embodiment the communication network 110 and the program transmission system 108 are the same.

In one embodiment, the network environment 100 also includes an external news server 126. The news server 126 and the provider 102 are in communication via a network 128. In a particular embodiment the networks 108, 110 and 128 are the same (e.g., the Internet). The news server 126 may also or alternatively communicate with each receiver 104. The news server 126 is generally configured to provide additional information which may be used to further enhance or augment the on-screen program guides executing on the receivers 104. Such enhancement may be accomplished by invoking the external information augmentation program 120.

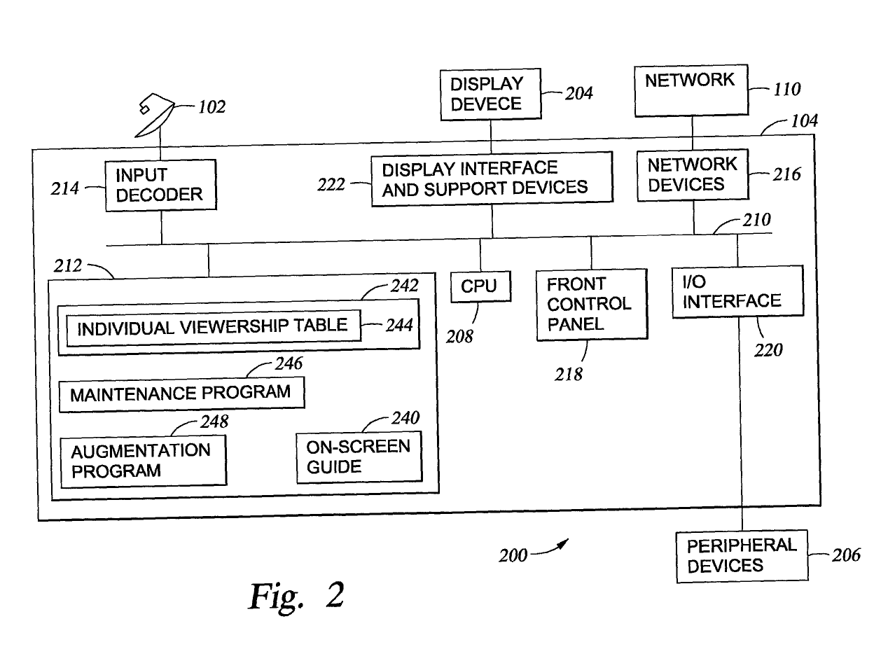

Each of the receivers 104 possesses the necessary hardware and software to receive program transmissions from the provider 102 as well as communicate other information to the provider 102. FIG. 2 shows one embodiment of a viewer's entertainment system 200 of which the receiver 104 forms a part. The entertainment system 200 includes the receiver 104 (a signal processing unit) connected to a display device 204 and one or more peripheral devices 206.

Illustrative peripheral devices 206 include, for example, a keyboard, keypad, light-pen, touch-screen, track-ball and speech recognition unit. The display device 204 is preferably any display screen (e.g., cathode ray tube, projection television and the like). In one embodiment, the display device 204 and some of the peripheral devices 206 could be combined. For example, a display screen with an integrated touch-screen, and a display with an integrated keyboard or a speech recognition unit combined with a text speech converter could be used.

Although shown separately, the display device 204 and the receiver 104 may be integrated. Alternatively, the receiver 104 is a stand-alone set-top box. In still another embodiment, the receiver 104, the display device 204 and the peripheral devices 206 are integrated with one another. Accordingly, in one embodiment, the entertainment system 200 is a portable device (e.g., handheld wireless device).

In general, the receiver 104 includes a Central Processing Unit (CPU) 208 connected via a bus 210 to a memory device 212, a receiver/decoder 214, a network device 216, a control panel 218, an I/O interface 220 and a display interface 222. Although shown together, the various components of the receiver 104 may in fact be separate components which, in some case, communicate with one another. In particular, the network device 216 configured to transmit and receive the viewership information may be in a separate unit from the decoder 214, which is configured to receive the video programming signal (i.e., the actual television programs to be viewed). In addition, it is noted that the raw viewership data may be output from the network device 216 while the processed viewership information is received from the input decoder 214 as part of the video programming signal.

The receiver/decoder 214 is configured to receive and process incoming signals from the provider 102 (illustratively shown as a satellite provider) via the program transmission system 108 (shown in FIG. 1). As noted above, the incoming signals at least include the television programs but may also include the viewership information. The incoming signals may also include the on-screen guide itself. In any case, the signals processed by the receiver/decoder 214 are then transmitted to the display device 204 through the display interface 222, which may include amplifiers, digital to analog converters and other support devices.

The network device 216 includes the necessary hardware support for connecting the receiver 104 with the communication network 110. Illustratively, the network device includes any of a telephone modem, cable modem, ISDN line, DSL line and the like.

Although shown as a single entity, the I/O interface 220 represents an entry/exit device for any number of peripheral devices 206. Illustrative peripheral devices are described above. In one embodiment, the peripheral devices also include a remote control (e.g., an infrared remote control) configured to transmit user command signals to the receiver 104. Alternatively or additionally, such command signals may be input via the control panel 218 (which may include various buttons, knobs, switches and the like).

Memory device 212 preferably comprises random access memory sufficiently large to hold the necessary programming and data structures. While memory device 212 is shown as a single entity, it should be understood that memory device 212 may in fact comprise a plurality of modules, and that memory 212 may exist at multiple levels, from high speed registers and caches to lower speed but larger DRAM chips. In addition, memory device 212 may also include read-only memory.

Memory 212 is shown containing an on-screen guide program 240, an augmentation program 248 and a maintenance program 246. In addition, the memory 212 includes a plurality of data structures 242 including an individual viewership table 244 which generally contains viewership behavior and profiles. The individual viewership table 244 is maintained by the maintenance program 246. The on-screen guide program 240 supports various graphical interfaces provided to subscribers via the display. Using the interfaces, the on-screen guide formats and displays the programming events being provided by the provider 102, as is known in the art. In addition, the on-screen guide program 240 provides graphical enhancements including a variety of viewership indicators. The graphical enhancements are made available by the augmentation program 248. Although shown separately, the augmentation program 248 may be integrated with the on-screen guide 240. Embodiments of viewership indicators are described below.

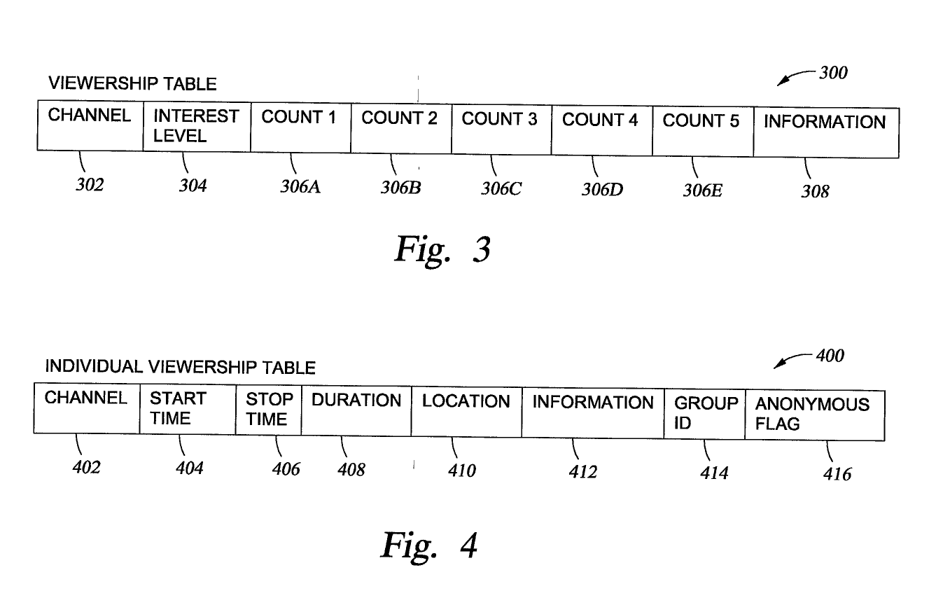

The particular features and implementations of an on-screen graphical interface are supported by the data structures posted by the provider 102 and/or those residing in the receiver 104. Illustrative embodiments of such data structures are described with reference to FIG. 3 and FIG. 4, respectively. Each of the data structures is organized as a plurality of rows and columns.

Referring first to FIG. 3, an embodiment of a record 300 from the aggregate viewership table 122 is shown. For simplicity, only a single row of the record 300 is shown. In general, each record 300 of the table 122 comprises a channel entry 302, an interest level entry 304, a plurality of count entries 306A-E and an information entry 308. The channel entry 302 is configured to contain a numeric identifier representing a television channel. The interest level entry 304 contains a value indicative of a current interest level in the programming occurring on the television channel indicated by channel entry 302. Illustratively, the current interest level value is calculated by determining the amount of time a determined number of people spend watching the particular television channel. Accordingly, the interest level value is increased when people stay tuned to the television channel for a predetermined time period. Conversely, the interest level value is decreased when people “surf” to the channel but do not spend an adequate amount of time tuned into the channel.

The count entries 306 each represent a number of people tuned into the channel indicated in the channel entry 302 for a particular time interval. A time interval is a predetermined time interval (e.g., five minutes) used in conjunction with the count entries 306 to determine if viewership on a particular channel is increasing or decreasing. Illustratively, a first count entry 306A represents a number of people tuned into the channel at a present time. A second count entry 306B represents a number of people tuned into the channel one time interval removed from the present time. For example, if the time interval is 5 minutes, then the second count entry 306B represents a number of people tuned into the channel five minutes ago (relative to the present time). A third count entry 306C represents a number of people tuned into the channel two time intervals removed from the present time. A fourth count entry 306D represents a number of people tuned into the channel three time intervals removed from the present time. A fifth count entry 306E represents a number of people tuned into the channel four time intervals removed from the present time. Although the record 300 contains four count entries in addition to the present time count entry, any number of entries may be provided.

The information contained in the information entry 308 may take on many forms and is generally dependent on the type of event being broadcast on the channel indicated in the channel entry 302. For example, if the event is a sporting event, then the information contained in the information entry 308 may include data such as score, game clock and other key indicators. As another example, if the event is a television show, then the information may include an indicator that the show has been delayed, that the show is a premier, special guests of the show, etc.

Referring now to FIG. 4, an embodiment of a record 400 from the individual viewership table 244 is shown. In general, each record 400 includes a channel entry 402, a start time entry 404, a stop time entry 406, a duration entry 408, a location entry 410, an information entry 412, a group identification (ID) entry 414 and an anonymous flag entry 416. The channel entry 402 contains a numeric value for a particular channel. The start time entry 404 contains a value representing the time the channel is first tuned in. The stop time entry 406 contains a value indicating when a viewer switched from the channel after the start time. The duration entry 408 contains a value derived by subtracting the stop time from the start time. Thus, the duration value indicates how long the channel was tuned in. A value in the location entry 410 describes the geographic location of the receiver 104 on which the particular individual viewership table 244 resides. The information entry 412 contains other data which may be useful in some embodiments. For example, the information entry 412 may contain profile information such as age, sex, likes, dislikes, television categories to include, television categories to exclude, etc. The information contained in information entry 412 may be configured by a viewer and multiple profiles may be created and maintained for multiple viewers.

The group identification (ID) entry 414 and an anonymous flag entry 416 support a group viewership feature. As used herein, a “group” is any number of two or more viewing entities. The purpose of forming a group is to facilitate selective communication of viewership information. The groups may be formed by mutual agreement of each group member. In one embodiment, the groups are formed by submission of written requests by viewing entities. Alternatively, viewers may contact one another directly to request membership. One particularly efficient method of direct communication is by means of the receivers 104. For example, the receivers 104 may each be configured with e-mail clients (or other messaging clients), thereby facilitating communication via a network (e.g., the Internet).

Upon formation of a group, the group is assigned a group identification (ID). Each member of the group is then provided with the group ID, which is stored in the group ID entry 414. In some cases, a group member may desire to remain anonymous. In such cases, the anonymous flag entry 416 may be used to advantage.

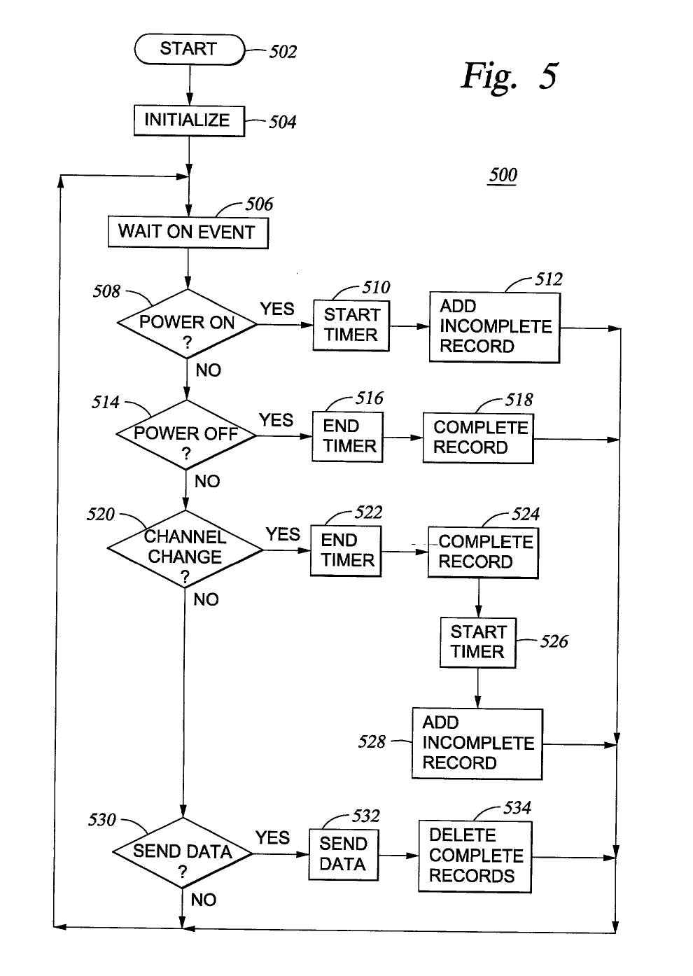

The following description describes methods for configuring an on-screen program guide using the programs and data structures described above. Referring first to FIG. 5, a method 500 is shown for maintaining the individual viewership table 244 residing on a receiver 104 by executing the maintenance program 246. The method 500 is entered at step 502 and proceeds to step 504 for initialization when the entertainment system 200 is powered up. The method 500 then waits on an event at step 506. When an event is signaled, the method 500 proceeds to determine the nature of the event and then handle the event accordingly. Illustratively, the determination of the nature of the event is represented as a series of queries at steps 508, 514, 520 and 530.

At step 508, the method 500 queries whether the event is to power up the entertainment system 200. If so, a timer is started at step 510 for the current channel to which the receiver 104 is tuned. At step 512, an incomplete record 400 is added to the individual viewership table 244. The record 400 is incomplete because the stop time (to be written to the stop time entry 406) is unknown. The method 500 then returns to step 506 to wait on another event.

At step 514, the method 500 queries whether the event is to power down. If so, the timer is stopped at step 516. At step 518 the individual viewership record 400 is completed by writing the stop time to the stop time entry 406 and calculating duration, which is then written to the duration entry 408. The method 500 then returns to step 506 to wait on another event.

At step 520, the method 500 queries whether the event is a change in the channel setting of the entertainment system 200. If so, the timer is ended at step 522 and the individual viewership record 400 is completed and added to the individual viewership table 244 at step 524 in the manner described above. This completes the record for the previous channel. It should be noted that the individual viewership record 400 may not be added to the individual viewership table 244 after each channel change when it is determined that a viewer is merely “passing through” a channel, as when a viewer is scanning channels. Accordingly, in some embodiments, a record 400 is not added unless the viewer has tuned into the channel for a minimum threshold amount of time. The timer is then restarted at step 522 for the current channel. Likewise, an incomplete record 400 is added to the individual viewership table 244 for the current channel. The method 500 then returns to step 506 to wait on another event.

At step 530, the method 500 queries whether the event is to send data (e.g., completed individual viewership record 400) to the provider 102. If so, the data is transmitted at step 532 and the corresponding completed records are deleted at step 534. As noted above, a receiver 104 may also be configured for communication with other receivers 104.

The transmission of data at step 532 may take place periodically. The frequency with which data is transmitted may be determined according to a particular implementation. In another embodiment, the data may be transmitted at the request of the provider 102. It is also contemplated that the data may be transmitted after a predefined number of channel changes.

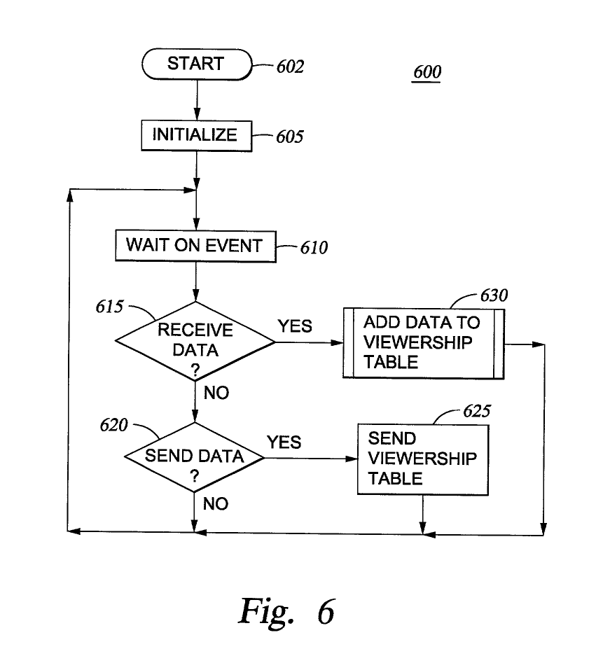

FIG. 6 shows a method 600 for sending and receiving on-screen guide information at the provider 102. Illustratively, the method 600 is initiated by executing the send/receive program 116. The method 600 is entered at step 602 and proceeds to step 605 for initialization. Following initialization, the method 600 proceeds to step 610 to wait on an event. When an event is signaled, the method 600 proceeds to step 615 and queries whether the event is to receive data from a receiver 104. If so, the method 600 proceeds to step 630 to process the incoming data (specifically, to add the data to the aggregate viewership table 122). The method 600 then returns to step 610 to wait on another event.

If step 615 is entered negatively, the method 600 proceeds to step 620 and queries whether the event is to send data to one or more receivers 104. Sending data may be prompted by functions of the provider itself or in response to a request received from a receiver 104. If the query at step 620 is entered negatively, the method 600 returns to step 610 to wait on another event. If the query is entered affirmatively, the aggregate viewership table information is transmitted at step 625. It is contemplated that the contents of the entire table 122 need not be sent at step 625. In some embodiments, the provider 102 may only send information pertinent to a particular receiver 104. For example, information may be provided for only those channels to which a viewing entity subscribes. In addition, group information may be provided only to group members. Further, the transmission may be in the form of “packets” or streaming data.

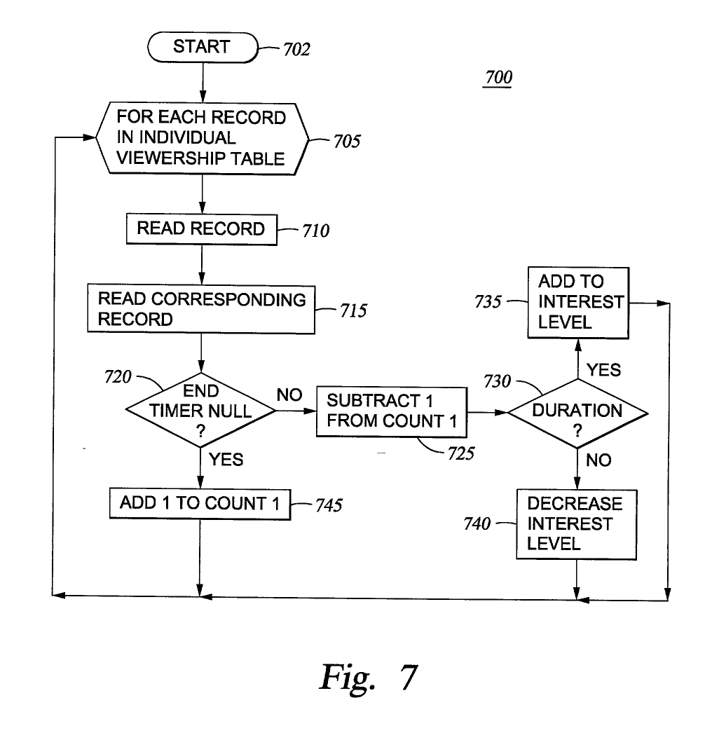

FIG. 7 shows a method 700 illustrating one embodiment of step 630. The method 700 is entered at step 702 and then enters a loop at step 705 to process all incoming records of an individual viewership table 244. If a record exists, the method 700 proceeds to step 710 where the record is read and column information is moved to local program variables. At step 715, the corresponding record in the aggregate viewership table 122 is read. A corresponding record is one in which the channel entry 402 of the individual viewership table record 400 matches the channel entry 302 of the aggregate viewership table record 300.

At step 720, the method 700 queries whether the value in the end time entry 406 is null. A non-null value implies that the television viewer has switched from the channel while a null value indicates the viewer is still tuned into the channel. Accordingly, if the value in the end time entry 406 is null, the first count entry 306A (which represents the number of viewers at present time) is incremented at step 745. The method 700 then returns to step 705 to process the next record 400 in the individual viewership table 244.

If, at step 720, the value in the end time entry 406 is other than null, the first count entry 306A is decremented at step 725. The method 700 then proceeds to step 730 to determine whether the duration during which the channel was tuned in indicates a level of interest by the viewer. This determination can be made with reference to the value contained in the duration entry 408 of the record 400. For example, the duration value may be compared against a threshold value. A duration value that exceeds the threshold value indicates a level of interest by the viewer. Accordingly, the interest level value contained in the entry 304 of the aggregate viewership table record 300 is increased at step 735. Otherwise, the interest level value is decreased at step 740. In either case, the method 700 returns to step 705 to begin processing another record.

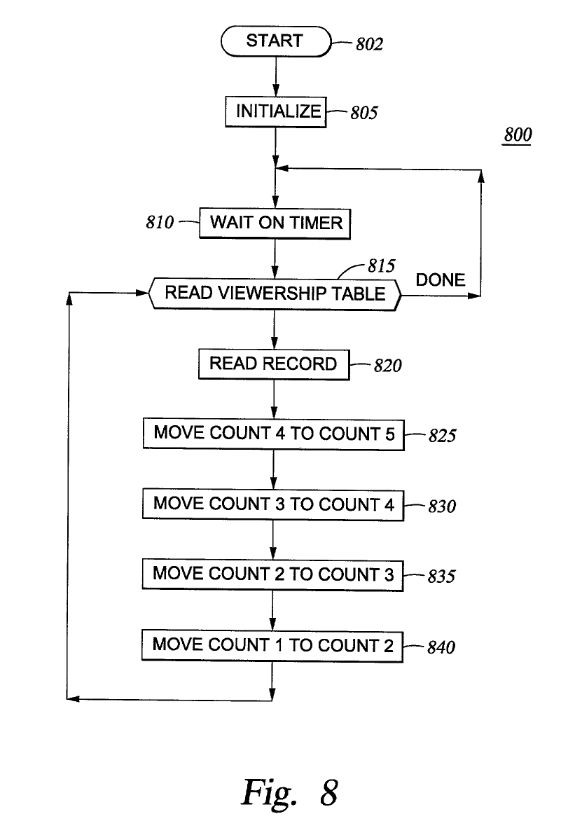

FIG. 8 shows a method 800 for determining increasing or decreasing viewer interest in a particular program. In one embodiment, the method 800 describes the execution of the viewership interest program 118. The method 800 enters at step 802 and proceeds to step 805 for initialization. Illustrative initialization steps include reading property values, such as how long to wait. Following initialization, the method 800 waits on a timer to expire at step 810. The timer may be set for any desired duration. In general, a shorter duration provides information that is closer to real-time information. Once the timer expires, the method 800 proceeds to step 815 to loop through all records 300 in the aggregate viewership table 122. If a record exists, then processing continues at step 820 where a record is read and column information is moved into local variables. At steps 825-840, the values contained in the count entries 306A-E are each moved to the next highest count entry 306 (or in the case of the fifth count entry 306E, discarded). The method 800 then returns to step 810 to repeat the process after the expiration of the timer.

In another embodiment, increasing or decreasing viewership interest (and related information) may be determined using the individual viewership table record 400. In particular, periodic reference may be made to the channel entry 402, the start time entry 404, the stop time entry 406 and the duration entry 408. In such an embodiment, the duration entry 408 contains a “running” value indicating the elapsed time since the viewer tuned into the channel indicated by the channel entry 402. So long as the stop time entry is null, the record 400 indicates continuing viewership by the viewer. At any given moment, the value contained in the duration entry 408 indicates the total viewing time on a particular channel. The viewing time for a particular program may then be determined with reference to the start time (and the programming schedule for the particular channel). For example, assume a viewer has been watching channel 200 for a period of sixty-two minutes (indicated by the value in the duration entry 408), beginning at 7:30 PM. Thus, the time is now 8:32 PM. Further, assume that an episode of “Who Wants to be a Millionaire” began at 8:00 PM. In this case, the viewer has been watching the program for a period of thirty-two minutes, which traverses two thirty-minute time slots.

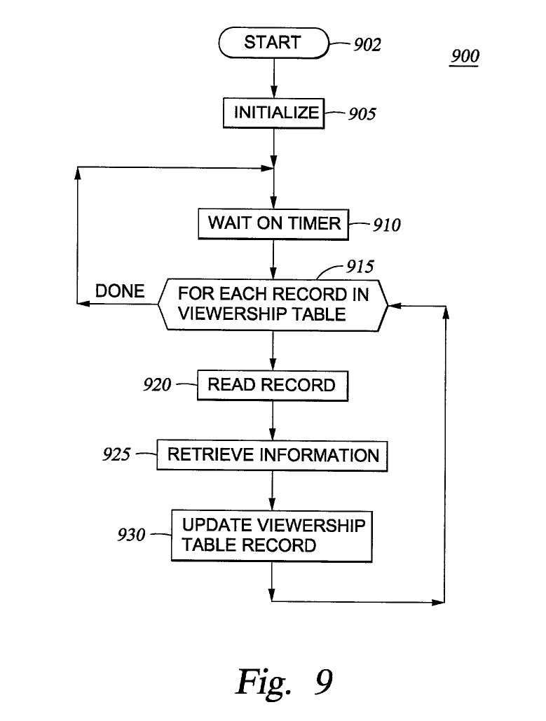

FIG. 9 shows a method 900 for populating the information entry 308 in the aggregate viewership record 300 with extra information, e.g., information provided by the external news server 126. As described above, such information can take on any of a variety of forms. Illustrative extra information includes a score for a sporting event, remaining time for a sporting event, reasons for a delay in schedule programming, reasons for extending a program, special guest appearances and the like.

The method 900 is entered at step 902 and proceeds to step 905 for initialization. Following initialization, the method 900 waits on the expiration of a timer at step 910. Once the timer expires, the method 900 enters a loop, at step 915, for each record in the aggregate viewership table 122. If the aggregate viewership table 122 contains at least one record, a first record is read at step 920. At step 925, extra information is received from an external source, e.g., the external news server 126. At step 930, the information entry 308 of the aggregate viewership table record 300 is updated to include the extra information.

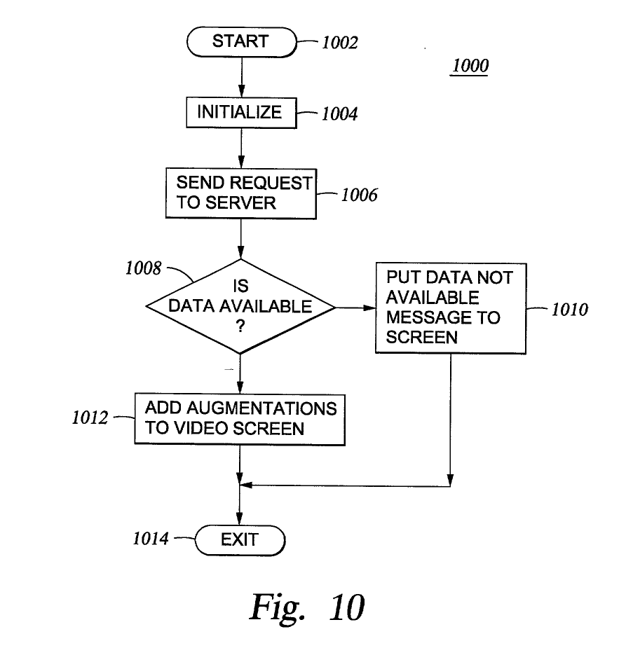

Referring to FIG. 10, a method 1000 is shown for enhancing or augmenting the on-screen guide 240. Illustratively, the method 1000 illustrates the operation of the augmentation program 248 in cooperation with the on-screen guide 240. The method 1000 is entered at step 1002 and proceeds to step 1004 for initialization. In one embodiment, the method 1000 is invoked by an explicit viewer request to see the viewership indicators. In another embodiment, the method 1000 is invoked each time a receiver 104 is powered up. In still another embodiment, the method 1000 is initiated when the on-screen guide is invoked. Following initialization, the receiver 104 sends a request to the provider 102 for viewership indicators data. Upon receiving a response, the receiver 104 determines whether the requested data was provided, at step 1008. If not, a message is output, at step 1010, to the display device 204 indicating to the viewer that the data is not available. If, however, the data is available at step 1008, the on-screen guide displayed on the display device 204 is configured with the viewership indicators at step 1012. The method 1000 then exits at step 1014.

While the method 1000 shows an explicit request sent to the provider 102, other embodiments do not include this step. For example, the provider 102 may itself be configured to periodically or continuously provide the viewership information, without requiring a request from a receiver 104. It should also be stated that, upon receiving viewership information, the receiver 104 may or may not output the viewership information to the display device 204 of the entertainment system 200. For example, where viewership information is indiscriminately provided to receivers in bulk, the receiver's 104 may have to filter the information according to user set preferences and other parameters. Filtering may be handled, for example, by the augmentation program 248.

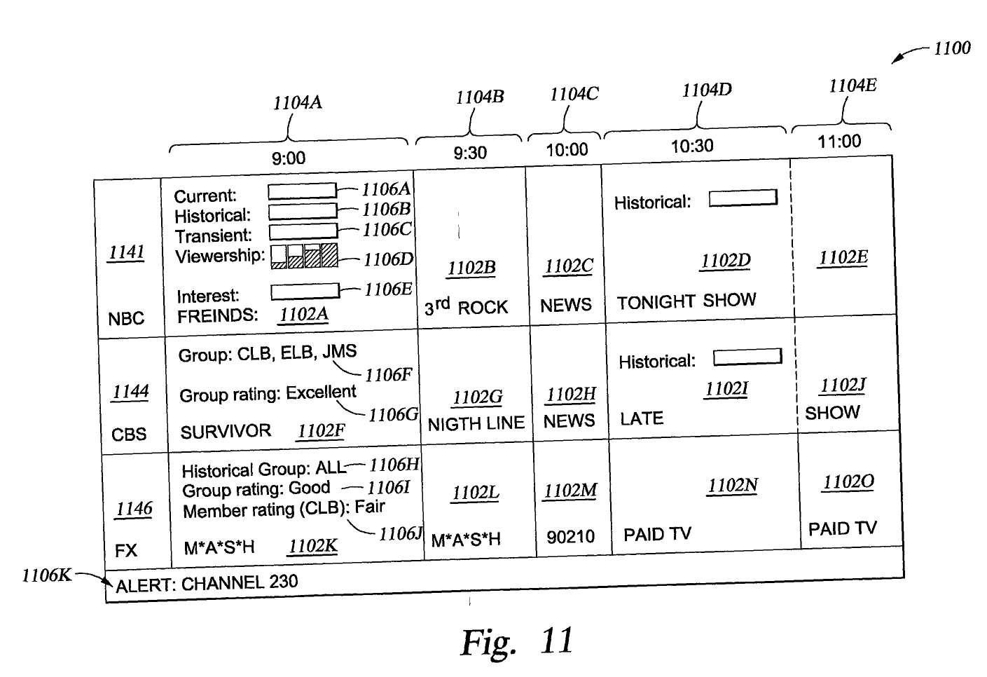

The foregoing data structures, programs and methods enable a variety of features for the on-screen guide. In general, the features include viewership indicators which convey information such as whether viewership is increasing or decreasing for a particular channel, viewership compared to other channels, or whether viewers are merely surfing over a channel staying tuned to the channel for a threshold amount of time. FIG. 11 illustrates embodiments of such features.

An exemplary on-screen interface 1100 is shown in FIG. 11. The interface 1100, which is output on the display device 204 under the control of the on-screen guide program 240, includes programming information for one or more programs transmitted to the receiver 104 by the provider 102. The programs are organized and displayed as a series of program entries 1102A-O. Each row of entries represents the programming for one channel provided by the provider 102. The displayed program entries include programs currently being transmitted as well as those scheduled for future transmission. Each program is displayed in one or more time slots 1104A-E where each time slot is a thirty-minute period. Illustratively, the programs currently being transmitted are those shown in a current time slot 1104A.

One or more of the program entries may be configured with one or more viewership indicators. As an example, a first programming entry 1102A is configured with five viewership indicators 1106A-E. Illustratively, the viewership indicators 1106A-E are bar graphs. However, in other embodiments the indicators include plain text messages, images, video and other data formats. Further, the viewership indicators may be graphical displays placed over the incoming video stream, much like sports scoreboards and weather alerts. It is also contemplated that the provider 102 may predefine portions of the video feed for the purpose of augmenting the feed with the viewership indicators. It is further contemplated that the provider 102 may send the online guide with the viewership indicators imbedded therein.

A current viewership indicator 1106A indicates the current number of viewers tuned into the program. A historical viewership indicator 1106B indicates an average number of viewers for the program. A transient viewership indicator 1106C indicates viewers who tuned into the program for a first minimum threshold period of time but then switched from the program before satisfying a second minimum threshold. Accordingly, the transient viewership indicator 1106C represents the “channel surfers” who for lack of interest or other reasons do not stay committed to a particular channel. A viewership indicator 1106D represents the increasing or decreasing number of viewers over time. This indicator is formatted using the count entries 306A-D. Illustratively, the viewership indicator 1106D is formatted as a horizontal bar graph, wherein the most current viewership poll is represented by the bar farthest to the right. Finally, an interest indicator 1106E represents a level of interest in the program and is formatted using the interest level entry 304.

Another programming entry 1102F is configured with a group indicator 1106F. The group indicator 1106F lists a number of viewing entities belonging to a common viewership group who are currently viewing the channel. The viewing members are identified by the provider 102 by the value contained in the group ID entry 414. The viewing members may be represented by name, initials or other descriptors. In the embodiment in which the individual viewership table 244 is configured with the anonymous flag 416, the group indicator 1106 lists only those group members who have not set the flag for anonymity.

Another programming entry 1102K is also configured with a historical group indicator 1106H. The historical group indicator 1106H lists a number of viewing entities belonging to a common viewership group. In one embodiment, the indicator 1106H may represent those in the group who typically (based on some threshold) watch the program. In another embodiment, the indicator 1106H may represent those in the group who have watched at least one episode of the program (or some specified fraction of one episode). Illustratively, the historical group indicator 1106 indicates that “ALL” members of the group typically watch the program indicated by the programming entry 1102K. In one embodiment, the historical viewership information may be parsed by individual, so that other members can determine who watched what.

The programming entries 1102F and 1102K are configured with a group rating indicator 1106G and 1106I, respectively. The group rating indicators 1106G and 1106I provide a collective measure of approval (or disapproval) from those members currently watching the program. Illustratively, a first group rating indicator1106G indicates an “excellent” rating for the program airing on channel 244 while a second group rating indicator 1106I indicates a “good” rating for the program airing on channel 246. In each case, the group rating may be determined by input received from the viewing group members themselves. For example, members may input viewing ratings to the receiver 104 using the peripheral devices 206. This data may then be transmitted to the provider 102 where other member data is collected, processed and transmitted back to the members. In another embodiment, the group rating is dependent upon the number of group members viewing the program in excess of a threshold number(s). In such an embodiment, it may be desirable to include only those group members who have viewed the program for some minimal period of time. Further, a tiered array of threshold numbers may be provided wherein a higher rating is associated with each higher tier.

Rather than a collective group rating, a member may also desire to see the individual ratings of each member (or selected members). Accordingly, a member rating indicator 1106J is provided. Illustratively, the indicator 1106J indicates that member CLB assigned the program a “fair” rating.

It should be noted that some programming entities are not configured with viewership indicators. This is because, in one embodiment, viewers may configure the on-screen program guide according to preference. Thus, viewers may determine which programming entries include viewership indicators. In addition, the viewers may determine which viewership indicators will be included in a particular programming entry.

In one embodiment, viewers are provided with an alert 1106K to indicate certain events. For example, the alert 1106K may indicate that a particular program is receiving significant attention, which may be defined by the size of the viewing audience or by the growth rate of the viewing audience, for example.

The foregoing indicators are merely illustrative. Persons skilled in the art will recognize that any variety of viewership information and other indicators are possible. For example, the viewership data may be processed according to a subset of the collective viewing population, e.g., men under 35 years of age. Illustratively, such subsetting may be accomplished using the information contained in the location entry 410 and information entry 412 of the individual viewership record 400. In addition, the manner in which the on-screen guide is formatted with the viewership information is susceptible to many embodiments all within the scope of the present invention.

While the foregoing is directed to embodiments of the present invention, other and further embodiments of the invention may be devised without departing from the basic scope thereof, and the scope thereof is determined by the claims that follow.

What is claimed is:

1. A method of providing viewership information to a plurality of television viewers, comprising:
collecting viewership data of a plurality of viewers;
processing the viewership data to provide on-screen interface information; and
transmitting, to a plurality of end-user receivers, the on-screen interface information, wherein the on-screen interface information is viewable on displays connected to the plurality of end-user receivers.

2. The method of claim 1, wherein transmitting the on-screen interface information comprises transmitting an interest level of the plurality of viewers in a particular program currently airing.

3. The method of claim 1, wherein transmitting the on-screen interface information comprises transmitting a growth rate of viewers for a particular program.

4. The method of claim 1, wherein the viewership data is collected from at least some of the plurality of end-user receivers.

5. The method of claim 1, wherein the plurality of viewers is at least a portion of the general television-viewing public.

6. The method of claim 1, wherein the on-screen interface information comprises historical viewership information and current viewership information.

7. The method of claim 1, wherein transmitting the on-screen interface information comprises transmitting group information comprising group members of a predefined group.

8. The method of claim 1, wherein transmitting the on-screen interface information comprises transmitting group information indicating how many members of a group are watching a program.

9. The method of claim 1, wherein transmitting the on-screen interface information comprises transmitting group information indicating a group rating for a program.

10. The method of claim 1, wherein transmitting the on-screen interface information comprises transmitting group information indicating which members of a group are watching a program.

11. The method of claim 10, wherein the members are identified by:
extracting member identification information from the viewership data; and
referencing a database containing group information.

12. The method of claim 1, wherein the on-screen interface information is on-screen program guide formatting information.

13. The method of claim 12, wherein the on-screen program guide information comprises programming information for a plurality of television channels.

14. The method of claim 1, wherein the on-screen interface information is transmitted from a television program provider servicing the plurality of viewers.

15. The method of claim 14, wherein the television program provider is one of a cable provider and a satellite provider.

16. A signal processing unit for processing television signals, comprising:
a first connector for receiving a video signal transmitted from a remote provider;
a second connector for receiving a viewership signal containing viewership data collected from a plurality of viewers;
a memory containing an on-screen guide interface formatable with the viewership data; and
a processor configured to format the on-screen guide interface with the viewership data.

17. The signal processing unit of claim 16, wherein the remote provider is one of a cable provider and a satellite provider.

18. The signal processing unit of claim 16, wherein the first connector and the second connector are a single common connector.

19. The signal processing unit of claim 16, wherein the viewership signal is transmitted by the remote provider.

20. The signal processing unit of claim 16, wherein the viewership data comprises viewership behavior information representing a behavior of viewers with respect to television programming.

21. The signal processing unit of claim 16, wherein the processor is configured to filter the viewership data.

22. The signal processing unit of claim 16, wherein the processor is configured to format an on-screen guide interface with viewership indicators using the viewership data.

23. The signal processing unit of claim 16, wherein the processor is configured to format an on-screen guide interface with viewership indicators using the viewership data, wherein the viewership indicators indicate viewership interest in at least one program being transmitted in the video signal.

24. The signal processing unit of claim 16, wherein the processor is configured to format an on-screen guide interface with viewership indicators using the viewership data, wherein the viewership indicators indicate viewership interest in at least one program being transmitted in the video signal.

25. An on-screen program guide information provider system, comprising:
a first network connection with a plurality of devices configured to collect viewership data of a plurality of television viewers;
a second network connection with a plurality of end-user receivers; and
a processor configured to:
(i) process the viewership data to provide on-screen guide formatting information;
(ii) transmit, via the second network connection, the on-screen guide formatting information to the plurality of end-user receivers, wherein the on-screen guide formatting information is used by the end-user receivers to output viewership indicators to displays connected to the plurality of end-user receivers.

26. The system of claim 25, wherein the on-screen guide formatting information comprises an interest level of the plurality of viewers in a particular program currently airing.

27. The system of claim 25, wherein the on-screen guide formatting information comprises a growth rate of viewers for a particular program.

28. The system of claim 25, wherein the on-screen guide formatting information comprises viewership behavior information representing a behavior of the plurality of viewers with respect to television programming.

29. The system of claim 25, wherein the first network connection and the second network connection are a same network connection.

30. The system of claim 25, wherein the plurality of devices and the plurality of end-user receivers are a same device.

31. The system of claim 25, wherein on-screen guide formatting information comprises a growth rate of viewers for a particular program.

32. The system of claim 25, further comprising a television program transmission system configured to transmit television program signals to the end-user receivers.

33. The system of claim 25, further comprising an external news server in communication with the processor.

34. The system of claim 25, wherein the viewership data is collected from at least some of the plurality of end-user receivers.

35. The system of claim 25, wherein each of the end-user receivers is located in different residential buildings.

36. The system of claim 25, wherein the plurality of television viewers is at least a portion of the general television-viewing public.

37. The system of claim 25, further comprising a database containing group information and wherein the processor is configured to determine which members of a group are watching a program using the group information and the viewership data.

38. The system of claim 25, further comprising a database containing group information and wherein the processor is configured to determine how many members of a group are watching a program using the group information and the viewership data.

39. A computer data signal embodied in a transmission medium, comprising on-screen program guide interface information containing viewership information of a plurality of television viewers, wherein the on-screen interface information is readable by a plurality of receivers having a network connection with a television program provider and wherein viewership information is configured for formatting an on-screen program guide.

40. The computer data signal of claim 39, wherein viewership information comprises viewer behavior information indicating a behavior of the plurality of television viewers with respect to television programs.

41. The computer data signal of claim 39, wherein the viewership information comprises current viewership information representing viewing behavior of the plurality of television viewers currently watching a television program.

42. The computer data signal of claim 39, wherein viewership information comprises at least one of historical viewership information and current viewership information.

43. The computer data signal of claim 39, further comprising programming information for a plurality of television channels.

44. The computer data signal of claim 39, wherein the viewership information comprises group information indicating which members of a group are watching a program.

45. The computer data signal of claim 39, wherein the viewership information comprises group information indicating how many members of a group are watching a program.

46. The computer data signal of claim 39, wherein the viewership information is transmitted from a television program provider servicing the plurality of television viewers.

47. The computer data signal of claim 46, wherein the television program provider is one of a cable provider and a satellite provider.
